(19) United States
(12) Patent Application Publication
(10) Pub. No.: US 2026/0350822 A1
(43) Pub. Date: Nov. 5, 2026

(54) METHOD AND APPARATUS FOR GENERATING THREE-DIMENSIONAL IMAGE DATA, AND ELECTRONIC DEVICE AND STORAGE MEDIUM

(71) Applicant: Beijing Zitiao Network Technology Co., Ltd., Beijing (CN)

(72) Inventors: Guangming YAO, Beijing (CN); Yi YUAN, Beijing (CN)

(21) Appl. No.: 19/488,375

(22) PCT Filed: May 29, 2024
(86) PCT No.: PCT/CN2024/096021

§ 371 Date: Nov. 26, 2025

(30) Foreign Application Priority Data
May 30, 2023 (CN) 202310627858.X

(51) Int. Cl. G06T 7/33; G06T 7/11; G06T 15/10

(52) U.S. Cl. CPC G06T 7/337; G06T 7/11; G06T 15/10; G06T 2207/30201

(57) ABSTRACT

The present disclosure relates to a method and apparatus for generating three-dimensional image data, and an electronic device and a storage medium. The method comprises: acquiring N frames of three-dimensional image data to be processed of a target object; performing rigid alignment on reference three-dimensional image data on the basis of a first frame of three-dimensional image data to be processed among the N frames of three-dimensional image data to be processed; and on the basis of the N frames of three-dimensional image data to be processed, performing non-rigid alignment on the reference three-dimensional image data, which has been subjected to rigid alignment, so as to determine a target three-dimensional image data sequence of the target object.

### CROSS-REFERENCE TO RELATED APPLICATIONS

The present application is based on and claims priority to Chinese Application No. 202310627858.X filed on May 30, 2023, the disclosure of which is incorporated by reference into the present application in its entirety.

### TECHNICAL FIELD

The present disclosure relates to the computer vision technical field, and in particular a three-dimensional image data generation method and apparatus, an electronic device, and a storage medium.

### BACKGROUND

Three-dimensional (3Dimensions, 3D) reconstruction refers to a 3D model reconstructed from one or more two-dimensional (2Dimensions, 2D) images. In related industries, using the 3D scanning technologies to obtain models with realistic target objects has become the mainstream, and this technology will become more and more popular as the price of 3D scanning hardware decreases.

### SUMMARY

The present disclosure provides a three-dimensional image data generation method and apparatus, an electronic device, and a storage medium.

According to a first aspect of the present disclosure, there is provided a three-dimensional image data generation method, the method comprising:
acquiring N frames of to-be-processed three-dimensional image data of a target object, the N frames of to-be-processed three-dimensional image data comprising a to-be-processed three-dimensional image data sequence of a target part of the target object obtained within a target period of time; where N is a positive integer greater than 1;
performing rigid alignment on reference three-dimensional image data based on a first frame of the N frames of to-be-processed three-dimensional image data;
performing non-rigid alignment on the rigidly aligned reference three-dimensional image data based on the N frames of to-be-processed three-dimensional image data so as to determine a target three-dimensional image data sequence of the target object; wherein the performing non-rigid alignment on the rigidly aligned reference three-dimensional image data based on the N frames of to-be-processed three-dimensional image data comprises performing non-rigid alignment on the reference three-dimensional image data that has been aligned with an (i−1)-th frame of to-be-processed three-dimensional image data based on the i-th frame of the N frames of to-be-processed three-dimensional image data to obtain the reference three-dimensional image data aligned with the i-th frame of to-be-processed three-dimensional image data; where i is a positive integer greater than 1.

According to a second aspect of the present disclosure, there is provided a three-dimensional image data generation apparatus, characterized in that the apparatus comprises:
a data acquisition module for acquiring N frames of to-be-processed three-dimensional image data of a target object, wherein the N frames of to-be-processed three-dimensional image data comprise a to-be-processed three-dimensional image data sequence of a target part of the target object obtained within a target period of time, where N is a positive integer greater than 1;
a rigid alignment module for performing rigid alignment on reference three-dimensional image data based on a first frame of the N frames of to-be-processed three-dimensional image data;
a non-rigid alignment module for performing non-rigid alignment on the rigidly aligned reference three-dimensional image data based on the N frames of to-be-processed three-dimensional image data so as to determine a target three-dimensional image data sequence of the target object; wherein the performing non-rigid alignment on the rigidly aligned reference three-dimensional image data based on the N frames of to-be-processed three-dimensional image data comprises performing non-rigid alignment on the reference three-dimensional image data that has been aligned with an (i−1)-th frame of to-be-processed three-dimensional image data based on an i-th frame of the N frames of to-be-processed three-dimensional image data to obtain the reference three-dimensional image data aligned with the i-th frame of to-be-processed three-dimensional image data; where i is a positive integer greater than 1.

According to a third aspect of the present disclosure, there is provided an electronic device. The electronic device comprises: a memory and a processor, wherein the memory stores a computer program thereon, and the processor implements the method as described above when executing the program.

According to a fourth aspect of the present disclosure, there is provided a computer-readable storage medium storing thereon a computer program, which, when executed by a processor, implements the above method of the present disclosure.

The three-dimensional image data generation method and apparatus, the electronic device, and the storage medium provided by the embodiment of the present disclosure acquire N frames of to-be-processed three-dimensional image data of a target object, perform rigid alignment on reference three-dimensional image data based on a first frame of the N frames of to-be-processed three-dimensional image data, and perform non-rigid alignment on the rigidly aligned reference three-dimensional image data based on the N frames of to-be-processed three-dimensional image data so as to determine a target three-dimensional image data sequence of the target object. In the alignment process, the embodiments of the present disclosure firstly perform rigid alignment between the reference three-dimensional image data and the first frame of the first frame of to-be-processed three-dimensional image data, and then, on the basis of the rigid alignment, perform non-rigid alignment on the rigidly aligned reference three-dimensional image data based on the N frames of to-be-processed three-dimensional image data to obtain the target three-dimensional image data sequence of the target object.

### BRIEF DESCRIPTION OF THE DRAWINGS

More details, features and advantages of the present disclosure are disclosed in the following description of exemplary embodiments taken in conjunction with the accompanying drawings, in which:

FIG. 1 is a flow diagram of a three-dimensional image data generation method provided by an exemplary embodiment of the present disclosure;

FIG. 2 is a flow diagram of step S120 in FIG. 1;

FIG. 3 is a schematic block diagram of functional modules of a three-dimensional image data generation apparatus provided by an exemplary embodiment of the present disclosure;

FIG. 4 is a structural block diagram of an electronic device provided by an exemplary embodiment of the present disclosure;

FIG. 5 is a structural block diagram of a computer system provided by an exemplary embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as being limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method implementation of the present disclosure can be performed in a different order and/or in parallel. Furthermore, the method implementation can include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of other terms will be given in the following description. It should be noted that the concepts such as “first” and “second” mentioned in the present disclosure are only used to distinguish different means, modules or units, and are not used to limit the order or interdependence of the functions performed by these means, modules or units.

It should be noted that the modifications of “one” and “multiple” mentioned in the present disclosure are schematic rather than limiting, and those skilled in the art should understand that unless the context clearly indicates otherwise, they should be understood as “one or multiple”.

Names of messages or information exchanged among a plurality of means in the implementations of the present disclosure are only used for illustrative purposes, and are not used to limit the scope of these messages or information.

In the related art, when a target object is scanned by a 3D scanning device, for example, a 3D grid sequence of the target object can be obtained after a period of scanning. Because the 3D grid sequence is obtained within a period of time and the state of the target object may change during the period of time, the topological structure of the corresponding 3D grids at different times within the period of time may be inconsistent, which goes against the subsequent applications of the 3D grid sequence in practice.

For the above problem, the present disclosure provides a three-dimensional image data generation method. In the embodiment provided by the present disclosure, a target part of a target object can be scanned by a three-dimensional scanning device, and the target object can be a person, for example, the target part can be the person's face or hand. In the embodiment, a face is taken as an example to explain, which is not limited in the embodiment. By obtaining multiple frames of to-be-processed three-dimensional image data of the face, and obtaining the corresponding multiple frames of images, these multiple frames of images can be obtained by camera shooting. Regarding the multiple frames of to-be-processed three-dimensional image data and the multiple frames of images in the embodiment, both “multiple frames” can be greater than or equal to 2, and the multiple frames in the embodiment refer to the to-be-processed three-dimensional image data or images in a timing relationship which are obtained within a period of time. The format of the images can be a RGB color mode (RGB), and the target object can be a specific person. The to-be-processed three-dimensional image data in the embodiment can be three-dimensional data that describes the target part of the target object by using a set formed by vertices of a polyhedron and polygons, and the polygon is at least one of triangle, quadrilateral or other simple convex polygon. In addition, the to-be-processed three-dimensional image data can also include three-dimensional data composed of ordinary polygons with voids, which is not limited in the embodiment.

The multiple frames of to-be-processed three-dimensional image data scanned by a three-dimensional scanning device may be used to scan out non-target parts such as clothes, collar and hair of a person in the scanning process, so it is necessary to preprocess these multiple frames of to-be-processed three-dimensional image data so as to remove them.

In the embodiment, face key points and face segmentation masks are extracted from the above images, and vertices of the face key points are labeled on the reference three-dimensional image data. The key points are local feature points in the face, which can be the specific facial positions such as eyes, nose, mouth or chin, or the feature points of the specific detail positions in the face such as eye sockets or nose wings, or the like. The embodiment of the present disclosure does not limit the number of face key points, which can be 49, 68 or 81, etc. In the embodiment, the number of face key points of 68 is took as an example. In addition, the reference three-dimensional image data can be a standard face model in a 3D Morphable Model (3DMM) library. It should be noted that the embodiment of the present disclosure takes a person as the target object and a face as the target part as an example for schematic explanation, and the target object or target part can also be others, for example, the target object can be a certain creature or object, and the target part can also be other part, etc., which are not limited in the embodiment. When the target object or the target part is other, it is also possible to extract the key points and the segmentation masks of the region where the target part is located according to its local features to perform alignment on the corresponding reference three-dimensional image data can based on the multiple frames of to-be-processed three-dimensional image data corresponding to the target part.

In the embodiment, for each frame of image, the face region can be segmented from the image by the face segmentation model to obtain the face segmentation mask. A certain number of face key points are extracted from the images, and the corresponding number of face key points are labeled on the reference three-dimensional image data. In this way, the face key points can be utilized to align a portion of the multiple frames of to-be-processed three-dimensional image data with the reference three-dimensional image data, for example, the reference three-dimensional image data can be aligned based on the first frame of the multiple frames of to-be-processed three-dimensional image data.

For example, taking the number of face key points of 68 as an example, the face key vertices P*∈R^{68×3} are labeled on the reference three-dimensional image data Mₜ, and for the i-th frame of image Iᵢ∈R^{H×W×3}, the part that does not belong to the face is removed by extracting the face key points Pᵢ∈R^{68×3}, obtaining the face segmentation masks Sᵢ∈R^{H×W}, and processing the multiple frames of to-be-processed three-dimensional image data of the scanned target object. For example, for each frame of to-be-processed three-dimensional image data Mᵢ, it is possible to project the vertices of the to-be-processed three-dimensional image data Mᵢ to the image coordinate system where the image Iᵢ corresponding to the to-be-processed three-dimensional image data Mᵢ is located by using a projection matrix, determine the non-face region in each frame of image Iᵢ by using the face segmentation masks Sᵢ corresponding to each frame of image Iᵢ, and remove the vertices projected in the non-face region in the to-be-processed three-dimensional image data Mᵢ. It is possible to record the to-be-processed three-dimensional image data obtained after processing as

$${M}_{i}^{process} ,$$

where n anu w represent the height and width of the image respectively, and i is a positive integer.

After preprocessing the multiple frames of initial to-be-processed three-dimensional image data of the scanned target object in the above way, the multiple frames of to-be-processed three-dimensional image data of the target object are obtained. Based on the above extracted face key points of each frame of image, rigid alignment is performed on the reference three-dimensional image data based on the first frame of these multiple frames of to-be-processed three-dimensional image data.

Specifically, it is possible to perform rigid alignment in the existing way, for example, it is possible to perform rigid alignment between the reference three-dimensional image data labeled with the face key points and the first frame of to-be-processed three-dimensional image data of the target object by using the Iterative Closest Point (ICP) method, and obtain the rigidly aligned standard three-dimensional image data, for example, a head model, which is not limited in the embodiment.

For example, by obtaining the scale s, rotation R and translation T, the above corresponding face key points are used to roughly align the reference three-dimensional image data Mₜ with the above to-be-processed three-dimensional image data

$${M}_{i}^{process}$$

obtained aner processing, which can be optimized by the following formula.

$${min}_{s , R , T} ‖ s * ( {RP}^{*} ) + T - {P}_{1}^{3 d} ‖ \qquad ( 1 )$$

where s is a scalar quantity, R is a 3×3 matrix, and T is a 1×3 vector;

$${P}_{1}^{3 d}$$

are three-dimensional race key points. The face key points of the first frame of image I₁ are obtained, the vertices of the first frame of to-be-processed three-dimensional image data

$${M}_{1}^{process}$$

are projected to the above image coordinate system, and the projection points nearest to the face key points in the first frame of image I₁ are determined respectively from the projection points obtained after projection, and the vertices of the to-be-processed three-dimensional image data

$${M}_{1}^{process}$$

corresponding to the nearest projection points are taken as

$${P}_{1}^{3 d} .$$

Through the above rigid alignment, the reference three-dimensional image data has a great deformation, which can allow the reference three-dimensional image data to be basically aligned with the first frame of to-be-processed three-dimensional image data of the target object.

In the embodiment, rigid alignment can be performed on the reference three-dimensional image data according to the first frame of the multiple frames of to-be-processed three-dimensional image data of the target object. The alignment result of performing rigid alignment between the reference three-dimensional image data and the first frame of to-be-processed three-dimensional image data is then utilized to perform non-rigid alignment on the rigidly aligned reference three-dimensional image data according to the first frame of to-be-processed three-dimensional image data. In the process of performing rigid alignment between the first frame of to-be-processed three-dimensional image data and the reference three-dimensional image data, the reference three-dimensional image data will have a great deformation, and non-rigid alignment is then performed on the rigidly aligned reference three-dimensional image data by using the first frame of to-be-processed three-dimensional image data, the rigidly aligned reference three-dimensional image data will have a decreased deformation.

After performing rigid alignment on the reference three-dimensional image data based on the face key points of the target object, the rigidly aligned reference three-dimensional image data can be utilized to perform non-rigid alignment with the multiple frames of to-be-processed three-dimensional image data respectively.

Specifically, firstly, for the first frame of the multiple frames of to-be-processed three-dimensional image data of a target object, non-rigid alignment is performed on the rigidly aligned reference three-dimensional image data according to the first frame of to-be-processed three-dimensional image data. The alignment result of performing non-rigid alignment between the rigidly aligned reference three-dimensional image data and the first frame of to-be-processed three-dimensional image data is utilized to perform non-rigid alignment on the aligned reference three-dimensional image data according to the second frame of to-be-processed three-dimensional image data. In the process of performing rigid alignment between the reference three-dimensional image data and the first frame of to-be-processed three-dimensional image data, the reference three-dimensional image data will have a great deformation. In the process of performing non-rigid alignment on the reference three-dimensional image data that has been aligned with the previous frame of to-be-processed three-dimensional image data according to the current frame of to-be-processed three-dimensional image data by using the alignment result of the previous frame of to-be-processed three-dimensional image data, alignment can be realized with a small deformation. In this way, non-rigid alignment is performed on the reference three-dimensional image data that has been aligned with the previous frame of to-be-processed three-dimensional image data by using the current frame of to-be-processed three-dimensional image data, until the non-rigid alignment based on the last frame of to-be-processed three-dimensional image data is completed, so that the alignment result of the previous frame can be utilized. On the basis, the reference three-dimensional image data that has been aligned with the previous frame is further deformed to make it fit for the current frame of to-be-processed three-dimensional image data, thus ensuring the topological consistency of the finally obtained target three-dimensional image data sequence.

It should be noted that the multiple frames of to-be-processed three-dimensional image data in the embodiment are a to-be-processed three-dimensional image data sequence obtained by scanning the target part of the target object within a period of time, and the to-be-processed three-dimensional image data sequence has timing information. For example, when the target part is a face, the multiple frames of to-be-processed three-dimensional image data can represent the expression change process of the face of the target object within a period of time, and the previous frame of to-be-processed three-dimensional image data and the current frame of to-be-processed three-dimensional image data have a timing relationship. Therefore, on the basis that the multiple frames of to-be-processed three-dimensional image data represent the same target part of the target object and have timing relationships, the multiple frames of to-be-processed three-dimensional image data can represent a continuous change of the contour shapes of the same target part within a period of time, especially the contour shapes represented by adjacent frames of to-be-processed three-dimensional image data are relatively close, so the alignment result of the previous frame of to-be-processed three-dimensional image data can be utilized. On this basis, the reference three-dimensional image data that has been aligned with the previous frame of to-be-processed three-dimensional image data is further aligned to obtain the alignment result corresponding to the current frame of to-be-processed three-dimensional image data. In the embodiment, it is necessary to utilize only the first frame of to-be-processed three-dimensional image data to perform rigid alignment on the reference three-dimensional image data, and it is unnecessary to perform rigid alignment between each frame of to-be-processed three-dimensional image data and the reference three-dimensional image data. Starting from the second frame of to-be-processed three-dimensional image data, alignment is performed on the reference three-dimensional image data that has been aligned on the basis of the alignment with the previous frame of to-be-processed three-dimensional image data, so that the obtained target three-dimensional image data sequence has a consistent topological structure. Moreover, in the process of utilizing the first frame of to-be-processed three-dimensional image data to perform rigid alignment on the reference three-dimensional image data, the reference three-dimensional image data has a great deformation, and the basic alignment on the reference three-dimensional image data has been realized. Subsequently, when the final target three-dimensional image data sequence is obtained by using each frame of to-be-processed three-dimensional image data, it is required to perform only a small deformation on the reference three-dimensional image data that has been rigidly aligned, which can improve the overall efficiency of alignment.

In the embodiment, multiple frames of to-be-processed three-dimensional image data are obtained by scanning the target object, and rigid alignment is performed on the reference three-dimensional image data according to the first frame of to-be-processed three-dimensional image data. On the basis of rigid alignment, non-rigid alignment is then performed, and the non-rigid alignment result of the previous frame is utilized. On this basis, non-rigid alignment is performed on the reference three-dimensional image data that has been aligned with the previous frame of to-be-processed three-dimensional image data by using the current frame of to-be-processed three-dimensional image data. For the reference three-dimensional image data that has been rigidly aligned with the first frame of to-be-processed three-dimensional image data, non-rigid alignment is performed again on the rigidly aligned reference three-dimensional image data according to the first frame of to-be-processed three-dimensional image data, so that the reference three-dimensional image data that has been subject to the above rigid alignment and non-rigid alignment can be more fit for the first frame of to-be-processed three-dimensional image data

$${M}_{1}^{process} .$$

For the target three-dimensional image data corresponding to the remaining frames of to-be-processed three-dimensional image data, they are obtained by a further deformation based on the non-rigid alignment result of the previous frame, so they can be also more fit for each of the remaining frames of to-be-processed three-dimensional image data.

Specifically, for Nᵥ vertices Vₜ∈R^{N}^{ᵥ}^{×3} of the rigidly aligned reference three-dimensional image data, the deformation parameter A∈R^{N}^{ᵥ}^{×3×3} and the translation parameter b∈R^{N}^{ᵥ}^{×3} are optimized by constructing a target loss function and utilizing the Adam optimizer. The target loss function L′ is specifically:

$${L}^{′} = {‖ ( {AV}_{pre} + b ) - {V}_{nearest} ‖}_{2} + α {‖ L ( {AV}_{pre} + b ) - {LV}_{t} ‖}_{2} + β {‖ Proj ( {AP}_{pre}^{*} + b ) - P ‖}_{2} + γ ( {‖ {M}_{f} ( A - H ) ‖}_{2} + {‖ {M}_{f} b ‖}_{2} ) + ϵ {\sum }_{[ i , jϵ ] {E}_{t}} ( {‖ {A}_{1}^{i} - {A}^{j} ‖}_{2} + ‖ {b}_{t}^{i} - {b}^{j} ‖ ) \qquad ( 20$$

For the first frame of to-be-processed three-dimensional image data, Vₚᵣₑ are the vertices Vₜ of the rigidly aligned reference three-dimensional image data. For the remaining frames of to-be-processed three-dimensional image data, Vₚᵣₑ are the vertices corresponding to the result after non-rigid alignment of the previous frame, and H represents a unit matrix. In addition, α and γ are regular terms, and their values can be set higher, thus ensuring the smoothness of the generated three-dimensional image data. The values of β and ε can be set lower. The specific weight coefficients α, β, γ and ε can be set to 1000, 10, 500 and 10, respectively.

The above target loss function L′ includes five parts:

### (1) Function of Nearest Neighbor Constraint:

∥(AVₚᵣₑ+b)−Vₙₑₐᵣₑₛₜ∥₂ (3)

When non-rigid alignment is performed between the Mᵢ-th frame of to-be-processed three-dimensional image data of the target object and the reference three-dimensional image data, Vₙₑₐᵣₑₛₜ is the vertice nearest to (AVₚᵣₑ+b) on the Mᵢ-th frame of to-be-processed three-dimensional image data, and the k-dimensional tree (K-Dtree) can be used to accelerate the acquisition of the nearest points. ∥·∥ represents the second norm, that is, the elements are summed and then subject to the square root calculation. A is the deformation parameter, and b is the translation parameter. When non-rigid alignment is performed on the rigidly aligned reference three-dimensional image data according to the first frame of to-be-processed three-dimensional image data, the function of nearest neighbor constraint can be used for constraining the distances between the vertices in the first frame of to-be-processed three-dimensional image data of the target object and the nearest vertices in the non-rigidly aligned reference three-dimensional image data. Moreover, when the non-rigid alignment result of the previous frame is utilized to perform non-rigid alignment on the reference three-dimensional image data that has been aligned with the previous frame of to-be-processed three-dimensional image data according to the current frame of to-be-processed three-dimensional image data, the function of nearest neighbor constraint can be used for constraining the distances between the vertices in the current frame of to-be-processed three-dimensional image data and the nearest vertices in the non-rigidly aligned reference three-dimensional image data. In this way, through a non-rigid deformation, the vertices in the non-rigidly aligned reference three-dimensional image data tend to coincide with the vertices of the corresponding frame of to-be-processed three-dimensional image data, so that the non-rigidly aligned reference three-dimensional image data is more fit for the to-be-processed three-dimensional image data of the target object.

### (2) Laplace Loss Function:

∥L(AVₚᵣₑ+b)−LVₜ∥₂ (4)
where, L is the Laplace matrix, which is expressed in the following way:

$${L}_{i , j} = \{ \begin{matrix}\begin{matrix}1 , i = j \\ 0 , j ∉ E ( i )\end{matrix} \\ - \frac{1}{{d}_{i}} , j ∈ E ( i )\end{matrix}$$

where, dᵢ is a degree of the i-th vertex (that is, the number of vertices in connection relationships with this point), and the smoothness of the non-rigidly deformed reference three-dimensional data is ensured by constraining the local Laplace coordinates to be unchanged. The Laplace loss function can also be called a function of smoothness constraint.

### (3) Function of Key Point Constraint:

$${‖ Proj ( {AP}_{pre}^{*} + b ) - P ‖}_{2} \qquad ( 5 )$$

The face key points after deformation of the reference three-dimensional image data are projected to the current frame of image of the target object, and the face key points after deformation of the reference three-dimensional image data are made as near to the key points in the current frame of image of the corresponding target object as possible.

$${P}_{pre}^{*}$$

is the face key points determined based on the reference three-dimensional image data that has been aligned with the previous frame of to-be-processed three-dimensional image data, and P is the result of the face key points of the image corresponding to the current frame of to-be-processed three-dimensional image data. For example, it can be the face key points P extracted from the current frame of image, or it can also be the face key points P of the current frame determined in other way.

### (4) Function of Non-Deformed Region Constraint:

∥M_{nf}(A₁−H)∥₂+∥M_{nf}b₁∥₂ (6)
where, M_{nf} is the segmentation mask of the non-deformed region, A₁ is the deformation parameter, and b1 is the translation parameter. By using the function of non-deformed region constraint, when non-rigid alignment is performed on the rigidly aligned reference three-dimensional image data according to the first frame of to-be-processed three-dimensional image data, and when the non-rigid alignment result of the previous frame is utilized to perform non-rigid alignment on the reference three-dimensional image data that has been aligned with the previous frame of to-be-processed three-dimensional image data according to the current frame of to-be-processed three-dimensional image data, it is possible to make the non-deformed region (such as the back of the head and teeth) in the non-rigidly aligned reference three-dimensional image data not deformed as much as possible. Therefore, for this non-deformed region, in the case where the deformation parameter is a matrix, the deformation matrix corresponding to the non-deformed region is a unit matrix, and the offset of the deformation is as close to 0 as possible.

### (5) Function of Rigidity Constraint:

$${\sum }_{\{ i , j \} ∈ {E}_{t}} ( {‖ ( {A}_{1}^{i} - {A}_{1}^{j} ) ‖}_{2} + ‖ ( {b}_{1}^{i} - {b}_{1}^{j} ) ‖ )$$

where

$${A}_{1}^{i}$$

and

$${A}_{1}^{j}$$

are deformation parameters corresponding to the i-t vertex and the j-th vertex in a vertex connection relationship respectively, and

$${b}_{1}^{i}$$

and

$${b}_{1}^{j}$$

are translation parameters corresponding to the i-th vertex and the j-th vertex in a vertex connection relationship, respectively.

By using the function of rigidity constraint, when non-rigid alignment is performed on the rigidly aligned reference three-dimensional image data according to the first frame of to-be-processed three-dimensional image data, and when the non-rigid alignment result of the previous frame is utilized to perform non-rigid alignment on the reference three-dimensional image data that has been aligned with the previous frame of to-be-processed three-dimensional image data according to the current frame of to-be-processed three-dimensional image data, it is possible to make the changes of the vertices in connection relationships in the non-rigidly aligned reference three-dimensional image data as near as possible, that is, both the difference between deformation terms and the difference between translation terms between the two vertices are as small as possible.

In the above way, based on the N frames of sequential images Iᵢ and the corresponding N frames of to-be-processed three-dimensional image data Mᵢ of the target object, and the projection matrix Pⱼ of K cameras, by deforming the reference three-dimensional image data Mₜ, N pieces of three-dimensional image data [symbol] with the same topological structure are finally output. Mᵢ={Vᵢ, Eᵢ}, i∈{1, . . . , N}, Vᵢ, Eᵢ are vertices and edges of the i-th frame of to-be-processed three-dimensional image data of the target object respectively; j∈{i, . . . , K}, Mₜ={Vₜ, Eₜ}, [symbol] ={ [symbol] , Eₜ}, both N and K are positive integers.

Based on the above embodiment, an embodiment of the present disclosure also provides a three-dimensional image data generation method. As shown in FIG. 1, the method can include the following steps:

In step S110, acquiring N frames of to-be-processed three-dimensional image data of a target object, wherein, the N frames of to-be-processed three-dimensional image data comprise a to-be-processed three-dimensional image data sequence of a target part of the target object obtained within a target period of time, where N is a positive integer greater than 1.

In the embodiment provided by the present disclosure, it is possible to scan the target part of the target object by a three-dimensional scanning device within the target period of time and obtain N frames of scanned to-be-processed three-dimensional image data, which can be three-dimensional grid data in the embodiment. For example, the target part of the target object is scanned in three dimensions at different times in a time sequence within a target period of time T to acquire the to-be-processed three-dimensional image data at different times, for example, the to-be-processed three-dimensional image data Mₓ at time t₁, time t₂, time t₃, time t₄, . . . , and time tₓ can be acquired, respectively, and each time corresponds to at least one frame of image I, where x is a positive integer.

In the embodiment, the to-be-processed three-dimensional image data Mᵢ corresponding to any time from the above time t₁ to time tₓ can be scanned by K cameras arranged at different positions at the time, where i is a positive integer.

It should be noted that the N frames of to-be-processed three-dimensional image data obtained in the embodiment can be a portion of the above time t₁ to time tₓ, for example, time t₁ to time t₄, or time t₂, time t₄, time t₅, which is not limited in the embodiment. The N frames of to-be-processed three-dimensional image data satisfy the sequence relationship in time sequence. The first frame of to-be-processed three-dimensional image data can be understood as the top frame in time sequence of the N frames of to-be-processed three-dimensional image data, and the second frame is a frame after the first frame and before the remaining frames of the to-be-processed three-dimensional image data.

In the embodiment provided by the present disclosure, if the target object is a person, the target part can be a face or a hand within the above period of time T, which is not limited in the present disclosure. Taking a face as an example, because the expression of the face can change within the period of time T, the finally obtained target three-dimensional image data sequence can represent the change process of the expression of the target object and has a consistent topology.

In the embodiment provided by the present disclosure, when the target part is a face, it is possible to scan the face of the target object by a three-dimensional scanning device to obtain N frames of scanned to-be-processed three-dimensional image data. Because the scanned N frames of to-be-processed three-dimensional image data may include non-target part regions such as clothes, collar or hair of a person, it is possible to preprocess the N frames of scanned to-be-processed three-dimensional image data to obtain the N frames of to-be-processed three-dimensional image data of the target object.

Specifically, the N frames of images of the target object can be obtained in the above way, and the N frames of images correspond to the N frames of to-be-processed three-dimensional image data of the target object. It is possible to project the obtained three-dimensional scanned data of the target object to the coordinate system corresponding to the N frames of images respectively to obtain the non-target part regions in the N frames of to-be-processed three-dimensional image data. By removing the vertices located in the non-target part regions, the N frames of to-be-processed three-dimensional image data of the target object are obtained.

In step S120, performing rigid alignment on reference three-dimensional image data based on a first frame of the N frames of to-be-processed three-dimensional image data.

In the embodiment, it is possible to acquire the key points in the first frame of to-be-processed three-dimensional image data, acquire the key points in the reference three-dimensional image data, and then transform the reference three-dimensional image data so that the key points in the transformed reference three-dimensional image data can approach the corresponding key points in the first frame of to-be-processed three-dimensional image data, respectively. The reference three-dimensional image data in the embodiment can be a self-created three-dimensional model or an existing standard three-dimensional model, which is not limited in the embodiment.

In step S130, performing non-rigid alignment on the rigidly aligned reference three-dimensional image data based on the N frames of to-be-processed three-dimensional image data so as to determine a target three-dimensional image data sequence of the target object.

The performing non-rigid alignment on the rigidly aligned reference three-dimensional image data based on the N frames of to-be-processed three-dimensional image data comprises performing non-rigid alignment on the reference three-dimensional image data that has been aligned with the (i−1)-th frame of to-be-processed three-dimensional image data based on the i-th frame of the N frames of to-be-processed three-dimensional image data to obtain the reference three-dimensional image data aligned with the i-th frame of to-be-processed three-dimensional image data; where i is a positive integer greater than 1. For example, rigid alignment and non-rigid alignment are performed on the reference three-dimensional image data Mₜ according to the first frame of to-be-processed three-dimensional image data M₁ to obtain the reference three-dimensional image data M_{1′} aligned with M₁, and non-rigid alignment is performed on M_{1′} according to the second frame of to-be-processed three-dimensional image data M₂ to obtain the aligned reference three-dimensional image data M_{2′}, and so on until the target three-dimensional image data sequence of the target object is obtained. In the embodiment, the target three-dimensional image data sequence of the target object is determined according to the aligned reference three-dimensional image data M_{1′}, M_{2′}, . . . , and their topological structures are consistent.

In the process of performing rigid alignment between the first frame of to-be-processed three-dimensional image data and the rigidly aligned reference three-dimensional image data, the reference three-dimensional image data will have a great deformation. In the process of performing non-rigid alignment on the reference three-dimensional image data that has been aligned with the previous frame of to-be-processed three-dimensional image data by the current frame of to-be-processed three-dimensional image data by using the alignment result of the previous frame of to-be-processed three-dimensional image data, non-rigid alignment can be realized with a small deformation. In this way, the alignment result of the previous frame can be utilized to further deform the reference three-dimensional image data that has been aligned with the previous frame so as to make it fit for the current frame of to-be-processed three-dimensional image data, thus ensuring the topological consistency of the finally obtained target three-dimensional image data sequence.

In the embodiment provided by the present disclosure, in the above step S130, specifically, it is also possible to perform non-rigid alignment on the rigidly aligned reference three-dimensional image data according to the first frame of to-be-processed three-dimensional image data. In this way, it is possible to further make the deformed reference three-dimensional image data fit for the first frame of to-be-processed three-dimensional image data. Moreover, performing non-rigid alignment on the rigidly aligned reference three-dimensional image data by utilizing the second frame of to-be-processed three-dimensional image data is on the basis of having performed alignment on the reference three-dimensional image data by utilizing the first frame of to-be-processed three-dimensional image data. If the alignment accuracy of the first frame of to-be-processed three-dimensional image data with the reference three-dimensional image data is high, the alignment accuracy and alignment efficiency of subsequent frames will be improved.

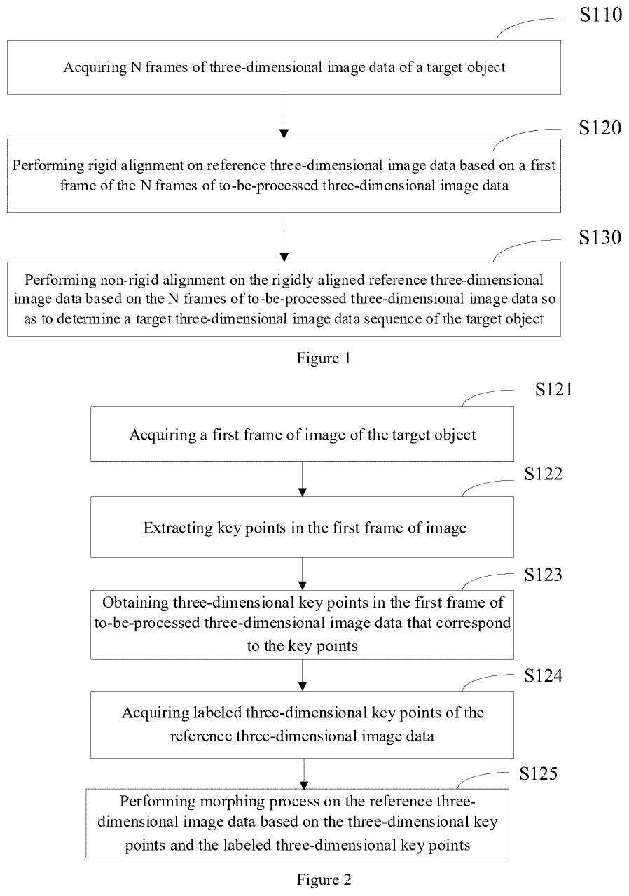

Based on the above embodiment, in another embodiment provided by the present disclosure, as shown in FIG. 2, the above step S120 can further specifically include the following steps.

In step S121, acquiring a first frame of image of the target object.

The first frame of image corresponds to the first frame of to-be-processed three-dimensional image data.

For example, the N frames of sequential images Ii and the corresponding N frames of to-be-processed three-dimensional image data Mᵢ of the target object can be obtained in the above way.

In step S122, extracting key points in the first frame of image.

In the embodiment, it is possible to extract key points in the images, such as face key points, by algorithms such as the Scale-Invariant Feature Transform (SIFT).

In step S123, obtaining three-dimensional key points in the first frame of to-be-processed three-dimensional image data that correspond to the key points.

In the embodiment, it is possible to acquire the face key points of the first frame of image I₁, project the vertices of the first frame of to-be-processed three-dimensional image data

$${M}_{1}^{process}$$

to the above image coordinate system, determine the projection points nearest to the face key points in the first frame of image I₁ from the projection points obtained after projection, respectively, and take the vertices of the first frame of to-be-processed three-dimensional image data

$${M}_{1}^{process}$$

corresponding to these nearest projection points as

$${P}_{1}^{3 d} .$$

In step S124, acquiring labeled three-dimensional key points of the reference three-dimensional image data.

The labeled key points of the reference three-dimensional image data correspond to the key points on the to-be-processed three-dimensional image data of the target object, such as the specific facial positions such as eyes, nose, mouth, or chin, or the feature points of the specific detail positions on the face such as eye sockets and nose wings involved in the above embodiment.

In step S125, performing morphing process on the reference three-dimensional image data based on the three-dimensional key points and the labeled three-dimensional key points.

In the embodiment, morphing process is performed on the reference three-dimensional image data to make the positions of the labeled key points of the reference three-dimensional image data consistent with the positions of the three-dimensional key points in the first frame of to-be-processed three-dimensional image data that correspond to the key points, which realizes the purpose of rigid alignment on the reference three-dimensional image data.

Based on the above embodiment, in another embodiment provided by the present disclosure, the above step S130 can specifically include: performing non-rigid alignment on the rigidly aligned reference three-dimensional image data based on the N frames of to-be-processed three-dimensional image data and the target constraint conditions. The target constraint conditions include at least one of nearest neighbor constraint, smoothness constraint, key point constraint, non-deformed region constraint and rigidity constraint.

In the embodiment, when the target constraint conditions include the nearest neighbor constraint, the smoothness constraint, the key point constraint, the non-deformed region constraint and the rigidity constraint, the weighted sum of functions of the nearest neighbor constraint, the smoothness constraint, the rigidity constraint, the key point constraint, the non-deformed region constraint and the rigidity constraint is minimum. The function of nearest constraint is used for constraining the distances between the vertices in the N frames of to-be-processed three-dimensional image data and the nearest vertices in the non-rigidly aligned reference three-dimensional image data; the function of smoothness constraint is used for constraining the Laplace coordinates of vertices in the non-rigidly aligned reference three-dimensional image data; the function of rigidity constraint is used for constraining the change degree between vertices in connection relationships in the non-rigidly aligned reference three-dimensional image data; the function of key point constraint is used for constraining the distances between the key points in the N frames of to-be-processed three-dimensional image data and the key points in the non-rigidly aligned reference three-dimensional image data. The function of non-deformed region constraint is used for constraining the change degree of the non-deformed regions in the non-rigidly aligned reference three-dimensional image data; the function of rigidity constraint is used for constraining the change degree between vertices in connection relationships in the non-rigidly aligned reference three-dimensional image data. In the embodiment, the target constraint condition can specifically be a target loss function constructed in the above embodiment. For details, please refer to the specific description in the above embodiment, which will not be repeated here.

Based on the above embodiment, in another embodiment provided by the present disclosure, the method can further include the following steps:

Step S211: acquiring N frames of initial to-be-processed three-dimensional image data and N frames of images of the target object; wherein the N frames of initial to-be-processed three-dimensional image data correspond to the N frames of images, respectively.

In the embodiment, the N frames of initial to-be-processed three-dimensional image data can be the initial to-be-processed three-dimensional image data of the target object obtained at different times within the target period of time. For example, the target part of the target object is scanned in three dimensions at different times according to the time sequence within the target period of time to acquire the to-be-processed three-dimensional image data at different times, the N frames of images are the images of the target object obtained at the above times, and the N frames of initial to-be-processed three-dimensional image data are in corresponding relationships with the N frames of images. For example, when the target object is a person, the initial to-be-processed three-dimensional image data can be the to-be-processed three-dimensional image data including a face, and the initial to-be-processed three-dimensional image data may also include hair, collar and the like of a person, so it is required to preprocess the initial to-be-processed three-dimensional image data.

In step S212, acquiring segmentation masks of the target part corresponding to the N frames of images respectively.

In the embodiment, for each frame of image, the face region can be segmented from the image by a face segmentation model to obtain the face segmentation mask.

Step S213: projecting the N frames of initial to-be-processed three-dimensional image data to the coordinate system corresponding to the N frames of images respectively, and determining vertices that do not belong to the target part in the N frames of initial to-be-processed three-dimensional image data based on the segmentation masks.

For example, for each frame of to-be-processed three-dimensional image data Mᵢ, it can be projected to the image coordinate system by a projection matrix, and the unit matrix H in each frame of image Iᵢ can be determined by utilizing the face segmentation mask Si corresponding to each frame of image Iᵢ.

Step S214: removing the vertices that do not belong to the target part in the N frames of initial to-be-processed three-dimensional image data to obtain the N frames of to-be-processed three-dimensional image data of the target object.

In the embodiment, by removing the vertices that do not belong to the target part from each frame of initial to-be-processed three-dimensional image data, for example, removing the vertices that do not belong to the face region, the N frames of to-be-processed three-dimensional image data of the target object can be obtained.

The three-dimensional image data generation method provided by the embodiment of the present disclosure can be used to acquire face training data, for example, in the training of a face 3D key point detection model and a virtual image expression driving model. Because the training data obtained by this corresponding method has a consistent topology, the model accuracy of the model obtained by training with the training data obtained by this method can also be further improved.

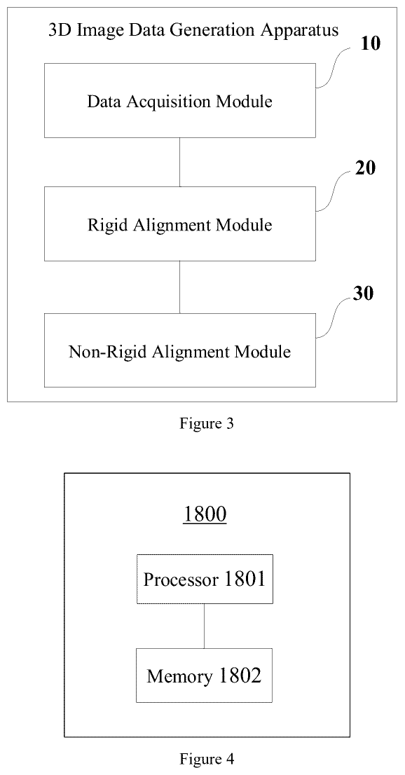

Under the condition that functional modules, into which the functions are divided, are used, an embodiment of the present disclosure provides a three-dimensional image data generation apparatus, which can be a server or a chip applied to the server. FIG. 3 is a schematic block diagram of functional modules of a three-dimensional image data generation apparatus provided by an exemplary embodiment of the present disclosure. As shown in FIG. 3, the three-dimensional image data generation apparatus includes:
a data acquisition module for acquiring N frames of to-be-processed three-dimensional image data of a target object, wherein the N frames of to-be-processed three-dimensional image data comprises a to-be-processed three-dimensional image data sequence of a target part of the target object obtained within a target period of time, where N is a positive integer greater than 1;
a rigid alignment module for performing rigid alignment on reference three-dimensional image data based on a first frame of the N frames of to-be-processed three-dimensional image data;
a non-rigid alignment module for performing non-rigid alignment on the rigidly aligned reference three-dimensional image data based on the N frames of to-be-processed three-dimensional image data so as to determine a target three-dimensional image data sequence of the target object; wherein the performing non-rigid alignment on the rigidly aligned reference three-dimensional image data based on the N frames of to-be-processed three-dimensional image data comprises performing non-rigid alignment on the reference three-dimensional image data that has been aligned with the (i−1)-th frame of to-be-processed three-dimensional image data based on the i-th frame of the N frames of to-be-processed three-dimensional image data to obtain the reference three-dimensional image data aligned with the i-th frame of to-be-processed three-dimensional image data; where i is a positive integer greater than 1.

Optionally, the non-rigid alignment module is further specifically used for:
performing non-rigid alignment on the rigidly aligned reference three-dimensional image data based on the N frames of to-be-processed three-dimensional image data and the target constraint conditions; wherein the target constraint conditions comprise at least one of the following: nearest neighbor constraint, smoothness constraint, rigidity constraint and key point constraint.

Optionally, the non-rigid alignment module is further specifically used for:
performing non-rigid alignment on the rigidly aligned reference three-dimensional image data according to the N frames of to-be-processed three-dimensional image data under the condition that the weighted sum of functions of the nearest neighbor constraint, the smoothness constraint, the rigidity constraint and the key point constraint is minimum;
wherein the function of nearest neighbor constraint is used for constraining the distances between vertices in the N frames of to-be-processed three-dimensional image data and the nearest vertices in the non-rigidly aligned reference three-dimensional image data; the function of smoothness constraint is used for constraining the Laplace coordinates of vertices in the non-rigidly aligned reference three-dimensional image data; the function of rigidity constraint is used for constraining the change degree between the vertices in connection relationships in the non-rigidly aligned reference three-dimensional image data; the function of key point constraint is used for constraining the distances between key points in the N frames of to-be-processed three-dimensional image data and key points in the non-rigidly aligned reference three-dimensional image data.

Optionally, the target constraint conditions further comprise a non-deformed region constraint; a function of the non-deformed region constraint is used for constraining the change degree of the non-deformed regions in the non-rigidly aligned reference three-dimensional image data; the non-rigid alignment module is further specifically used for:
performing non-rigid alignment on the rigidly aligned reference three-dimensional image data according to the N frames of to-be-processed three-dimensional image data under the condition that the weighted sum of functions of the nearest neighbor constraint, the smoothness constraint, the key point constraint, the non-deformed region constraint, and the rigidity constraint is minimum.

Optionally, the rigid alignment module is further specifically used for:
acquiring a first frame of image of the target object; the first frame of image corresponds to the first frame of to-be-processed three-dimensional image data;
extracting key points in the first frame of image;
obtaining three-dimensional key points in the first frame of to-be-processed three-dimensional image data that correspond to the key points;
acquiring labeled three-dimensional key points of the reference three-dimensional image data;
performing morphing process on the reference three-dimensional image data based on the three-dimensional key points and the labeled three-dimensional key points.

Optionally, the rigid alignment module is further specifically used for:
performing non-rigid alignment on the rigidly aligned reference three-dimensional image data according to the first frame of to-be-processed three-dimensional image data.

In another embodiment provided by the present disclosure, the apparatus further comprises:
a data acquisition module for acquiring N frames of initial to-be-processed three-dimensional image data and N frames of images of the target object; wherein the N frames of initial to-be-processed three-dimensional image data correspond to the N frames of images, respectively;
a segmentation mask acquisition module for acquiring segmentation masks of the target part corresponding to the N frames of images, respectively;
a determination module for projecting the N frames of initial to-be-processed three-dimensional image data to the coordinate system corresponding to the N frames of images, respectively, and determining the vertices that do not belong to the target part in the N frames of initial to-be-processed three-dimensional image data based on the segmentation masks;
a removal module for removing the vertices that do not belong to the target part in the N frames of initial to-be-processed three-dimensional image data to obtain the N frames of to-be-processed three-dimensional image data of the target object.

Since the apparatus part in the embodiment corresponds to the above method part, please refer to the description of the above method embodiment for details, which will not be repeated here.

The three-dimensional image data generation apparatus provided by the embodiment of the present disclosure acquires N frames of to-be-processed three-dimensional image data of a target object, performs rigid alignment on reference three-dimensional image data based on a first frame of the N frames of to-be-processed three-dimensional image data, and performs non-rigid alignment on the rigidly aligned reference three-dimensional image data based on the N frames of to-be-processed three-dimensional image data so as to determine a target three-dimensional image data sequence of the target object. In the alignment process, the embodiment of the present disclosure firstly performs rigid alignment between the reference three-dimensional image data and the first frame in the first frame of to-be-processed three-dimensional image data, and then on the basis of the rigid alignment, performs non-rigid alignment on the rigidly aligned reference three-dimensional image data based on the N frames of three-dimensional image data to obtain the target three-dimensional image data sequence of the target object. In this way, in the alignment process, the alignment result of the previous frame can be utilized to further deform the reference three-dimensional image data that has been aligned with the previous frame so as to make it fit for the current frame of to-be-processed three-dimensional image data, thus ensuring the topological consistency of the finally obtained target three-dimensional image data sequence.

An embodiment of the disclosure also provides an electronic device, which comprises at least one processor; a memory for storing instructions executable for the at least one processor; wherein the at least one processor is configured to execute the instructions so as to implement the above method disclosed in the embodiment of the present disclosure.

FIG. 4 is a structural schematic diagram of an electronic device provided by an exemplary embodiment of the present disclosure. As shown in FIG. 4, the electronic device 1800 includes at least one processor 1801 and a memory 1802 coupled to the processor 1801, and the processor 1801 can perform the corresponding steps in the above method disclosed in the embodiment of the present disclosure.

The above processor 1801 can also be called a central processing unit (CPU), which can be an integrated circuit chip with signal processing capability. Each step in the above method disclosed in the embodiment of the present disclosure can be completed by an integrated logic circuit of hardware or instructions in the form of software in the processor 1801. The above processor 1801 can be a general processor, digital signal processor (DSP), ASIC, field-programmable gate array (FPGA) or other programmable logic devices, discrete gate or transistor logic devices, or discrete hardware components. The general processor can be a microprocessor or the processor can be any conventional processor, etc. The steps of the method disclosed in combination with the embodiment of the present disclosure can be directly embodied as being performed by a hardware decoding processor, or by a combination of hardware and software modules in the decoding processor. The software module can be located in the memory 1802, such as random access memory, flash memory, read-only memory, programmable read-only memory or electrically erasable programmable memory, register and other mature storage media in the art. The processor 1801 reads information in the memory 1802 and completes the steps of the above method in combination with its hardware.

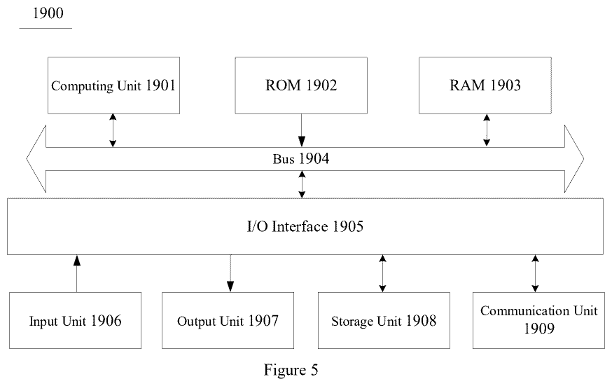

In addition, under the condition that various operations/processes according to the present disclosure are implemented by software and/or firmware, programs constituting the software can be installed from a storage medium or a network to a computer system with a dedicated hardware structure, such as a computer system 1900 shown in FIG. 5, and the computer system, when installed with various programs, can perform various functions, including such functions as those described above. FIG. 5 is a structural block diagram of a computer system provided by an exemplary embodiment of the present disclosure.

The computer system 1900 is intended to represent various forms of digital electronic computer devices, such as laptop computer, desktop computer, workstation, personal digital assistant, server, blade server, mainframe computer, and other suitable computers. Electronic devices can also represent various forms of mobile devices, such as personal digital processing, cellular phone, smart phone, wearable device and other similar computing devices. The parts shown herein, their connections and relationships, and their functions are only examples, and are not intended to limit the implementation of the present disclosure described and/or claimed herein.

As shown in FIG. 5, a computer system 1900 includes a computing unit 1901, which can perform various suitable actions and processes according to computer programs stored in a read-only memory (ROM) 1902 or computer programs loaded from a storage unit 1908 into a random access memory (RAM) 1903. In the RAM 1903, various programs and data required for the operation of the computer system 1900 can also be stored. The computing unit 1901, the ROM 1902 and the RAM 1903 are connected to each other through a bus 1904. An input/output (I/O) interface 1905 is also connected to the bus 1904.

A plurality of components in the computer system 1900 are connected to the I/O interface 1905, including: an input unit 1906, an output unit 1907, a storage unit 1908 and a communication unit 1909. The input unit 1906 can be any type of device that can input information to the computer system 1900, and the input unit 1906 can receive input numeric or character information and generate key signal input related to user settings and/or functional control of the electronic device. The output unit 1907 can be any type of device capable of presenting information, and can include but not limited to display, speaker, video/audio output terminal, vibrator and/or printer. The storage unit 1908 can include, but is not limited to, magnetic disk and optical disk. The communication unit 1909 allows the computer system 1900 to exchange information/data with other devices through a network such as the Internet, and can include but not limited to modem, network card, infrared communication device, wireless communication transceiver and/or chipset, such as Bluetooth™ device, WiFi device, WiMax device, cellular communication device and/or the like.

The computing unit 1901 can be various general and/or dedicated processing components with processing and computing capabilities. Some examples of the computing unit 1901 include, but are not limited to, central processing unit (CPU), graphics processing unit (GPU), various dedicated artificial intelligence (AI) computing chips, various computing units running machine learning model algorithms, a digital signal processor (DSP), and any suitable processor, controller, microcontroller, etc. The computing unit 1901 performs the various methods and processes described above. For example, in some embodiments, the above method disclosed in the embodiments of the present disclosure can be implemented as a computer software program tangibly embodied in a machine-readable medium, such as the storage unit 1908. In some embodiments, a portion or all of the computer program can be loaded and/or installed on the electronic device 1900 through the ROM 1902 and/or the communication unit 1909. In some embodiments, the computing unit 1901 can be configured to perform the above method disclosed in the embodiments of the present disclosure in any other suitable way (for example, by means of firmware).

An embodiment of the present disclosure also provides a computer-readable storage medium, wherein instructions in the computer-readable storage medium, when executed by a processor of an electronic device, enable the electronic device to perform the above method disclosed in embodiment of the present disclosure.

The computer-readable storage medium in the embodiment of the present disclosure can be a tangible medium, which can contain or store programs for use by or in combination with an instruction execution system, apparatus or device. The above computer-readable storage medium can include, but is not limited to, an electronic, magnetic, optical, electromagnetic, infrared, or semiconductor system, apparatus or device, or any suitable combination of the above. More specifically, the above computer-readable storage medium can include electrical connection based on one or more wires, portable computer disk, hard disk, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the above.

The above computer-readable medium can be included in the above electronic device; or it can exist alone without being assembled into the electronic device.

An embodiment of the present disclosure also provides a computer program product, including a computer program, wherein the computer program, when executed by a processor, implements the above method disclosed in the embodiment of the present disclosure.

In the embodiments of the present disclosure, computer program codes for performing the operations of the present disclosure can be written in one or more programming languages or their combinations, including but not limited to object-oriented programming languages such as Java, Smalltalk, C++, and conventional procedural programming languages such as “C” or similar programming languages. The program codes can be completely executed on a user's computer, partially executed on the user's computer, executed as an independent software package, partially executed on the user's computer and partially executed on a remote computer, or completely executed on the remote computer or a server. In the case involving a remote computer, the remote computer can be connected to a user computer through any kind of network, including a local area network (LAN) or a wide area network (WAN), or can be connected to an external computer.

The flow diagrams and block diagrams in the drawings illustrate the architecture, functions and operations of possible implementations of the system, the method and the computer program product according to various embodiments of the present disclosure. In this regard, each block in the flow diagrams or block diagrams can represent a module, a program segment, or a portion of codes that contain one or more executable instructions for implementing specified logical functions. It should also be noted that in some alternative implementations, the functions labeled in the blocks can occur in a different order than those labeled in the drawings. For example, two blocks shown in succession can actually be executed substantially in parallel, and they can sometimes be executed in the reverse order, depending on the functions involved. It should also be noted that each or a combination of blocks in the block diagrams and/or flow diagrams can be implemented by a dedicated hardware-based system that performs specified functions or operations, or by a combination of dedicated hardware and computer instructions.

The involved modules, components or units described in the embodiments of the present disclosure can be implemented by software or hardware. The names of the modules, components or units do not constitute the limitation of the modules, components or units themselves in some cases.

The functions described above herein can be at least partially performed by one or more hardware logic components. For example, without limitation, exemplary hardware logic components that can be used include: field programmable gate array (FPGA), application specific integrated circuit (ASIC), application specific standard product (ASSP), system on chip (SOC), complex programmable logic device (CPLD) and so on.

The above descriptions are only some embodiments of the present disclosure and explanations of the applied technical principles. It should be understood by those skilled in the art that the disclosure scope involved in the present disclosure is not limited to the technical solution formed by the specific combination of the above technical features, but also covers other technical solutions formed by any combination of the above technical features or their equivalent features without departing from the above disclosure concept, for example, the technical solution formed by mutual replacement of the above features and technical features with similar functions disclosed in the present disclosure (but not limited to).

Although some specific embodiments of the present disclosure have been described in detail through examples, it should be understood by those skilled in the art that the above examples are only for illustration and are not intended to limit the scope of the present disclosure. It should be understood by those skilled in the art that the above embodiments can be modified without departing from the scope and spirit of the present disclosure. The scope of the present disclosure is defined by the appended claims.

1. A three-dimensional image data generation method, the method comprising:
acquiring N frames of to-be-processed three-dimensional image data of a target object, wherein the N frames of to-be-processed three-dimensional image data comprise a to-be-processed three-dimensional image data sequence of a target part of the target object obtained within a target period of time, wherein N is a positive integer greater than 1;
performing rigid alignment on reference three-dimensional image data based on a first frame of the N frames of to-be-processed three-dimensional image data; and
performing non-rigid alignment on the rigidly aligned reference three-dimensional image data based on the N frames of to-be-processed three-dimensional image data so as to determine a target three-dimensional image data sequence of the target object; wherein the performing non-rigid alignment on the rigidly aligned reference three-dimensional image data based on the N frames of to-be-processed three-dimensional image data comprises performing non-rigid alignment on the reference three-dimensional image data that has been aligned with an (i−1)-th frame of to-be-processed three-dimensional image data based on an i-th frame of the N frames of to-be-processed three-dimensional image data to obtain the reference three-dimensional image data aligned with the i-th frame of to-be-processed three-dimensional image data, wherein i is a positive integer greater than 1.

2. The method according to claim 1, wherein the performing non-rigid alignment on the rigidly aligned reference three-dimensional image data comprises:
performing non-rigid alignment on the rigidly aligned reference three-dimensional image data based on the N frames of to-be-processed three-dimensional image data and target constraint conditions; wherein the target constraint conditions comprise at least one of the following: nearest neighbor constraint, smoothness constraint, rigidity constraint, and key point constraint.

3. The method according to claim 2, wherein the performing non-rigid alignment on the rigidly aligned reference three-dimensional image data based on the N frames of to-be-processed three-dimensional image data and the target constraint conditions comprises:
performing non-rigid alignment on the rigidly aligned reference three-dimensional image data according to the N frames of to-be-processed three-dimensional image data under the condition that the weighted sum of a function of the nearest neighbor constraint, a function of the smoothness constraint, a function of the rigidity constraint and a function of the key point constraint is minimum;
wherein the function of the nearest neighbor constraint is configured for constraining distances between vertices in the N frames of to-be-processed three-dimensional image data and nearest vertices in the non-rigidly aligned reference three-dimensional image data; the function of the smoothness constraint is configured for constraining Laplace coordinates of vertices in the non-rigidly aligned reference three-dimensional image data; the function of the rigidity constraint is configured for constraining change degrees between the vertices having connection relationships in the non-rigidly aligned reference three-dimensional image data; the function of the key point constraint is configured for constraining distances between key points in the N frames of to-be-processed three-dimensional image data and key points in the non-rigidly aligned reference three-dimensional image data.

4. The method according to claim 2, wherein the target constraint conditions further comprise a non-deformed region constraint, and a function of the non-deformed region constraint is configured for constraining a change degree of non-deformed regions in the non-rigidly aligned reference three-dimensional image data; the performing non-rigid alignment on the rigidly aligned reference three-dimensional image data based on the N frames of to-be-processed three-dimensional image data and the target constraint conditions comprises:
performing non-rigid alignment on the rigidly aligned reference three-dimensional image data according to the N frames of to-be-processed three-dimensional image data under the condition that the weighted sum of the function of the nearest neighbor constraint, the function of the smoothness constraint, the function of the key point constraint, the function of the non-deformed region constraint and the function of the rigidity constraint is minimum.

5. The method according to claim 1, wherein the performing rigid alignment on the reference three-dimensional image data based on the first frame of the N frames of to-be-processed three-dimensional image data comprises: performing rigid alignment between the first frame of to-be-processed three-dimensional image data and the reference three-dimensional image data based on key points of the first frame of to-be-processed three-dimensional image data of the target part, which comprises:
acquiring a first frame of image of the target object, wherein the first frame of image corresponds to the first frame of to-be-processed three-dimensional image data;
extracting key points in the first frame of image;
obtaining three-dimensional key points in the first frame of to-be-processed three-dimensional image data that correspond to the key points;
acquiring labeled three-dimensional key points of the reference three-dimensional image data; and
performing morphing process on the reference three-dimensional image data based on the three-dimensional key points and the labeled three-dimensional key points.

6. The method according to claim 1, wherein the performing non-rigid alignment on the rigidly aligned reference three-dimensional image data based on the N frames of to-be-processed three-dimensional image data comprises:
performing non-rigid alignment on the rigidly aligned reference three-dimensional image data according to the first frame of to-be-processed three-dimensional image data.

7. The method according to claim 1, wherein the method further comprises:
acquiring N frames of initial to-be-processed three-dimensional image data and N frames of images of the target object; wherein the N frames of initial to-be-processed three-dimensional image data correspond to the N frames of images, respectively;
acquiring segmentation masks of the target part corresponding to the N frames of images, respectively;
projecting the N frames of initial to-be-processed three-dimensional image data to a coordinate system corresponding to the N frames of images, respectively, and determining the vertices that do not belong to the target part in the N frames of initial to-be-processed three-dimensional image data based on the segmentation masks; and
removing the vertices that do not belong to the target part in the N frames of initial to-be-processed three-dimensional image data to obtain the N frames of to-be-processed three-dimensional image data of the target object.

8. (canceled)

9. An electronic device, comprising:
at least one processor;
a memory for storing instructions executable by the at least one processor;
wherein the at least one processor is configured to execute the instructions so as to implement a three-dimensional image data generation method, comprising:
acquiring N frames of to-be-processed three-dimensional image data of a target object, wherein the N frames of to-be-processed three-dimensional image data comprise a to-be-processed three-dimensional image data sequence of a target part of the target object obtained within a target period of time, wherein N is a positive integer greater than 1;
performing rigid alignment on reference three-dimensional image data based on a first frame of the N frames of to-be-processed three-dimensional image data; and
performing non-rigid alignment on the rigidly aligned reference three-dimensional image data based on the N frames of to-be-processed three-dimensional image data so as to determine a target three-dimensional image data sequence of the target object; wherein the performing non-rigid alignment on the rigidly aligned reference three-dimensional image data based on the N frames of to-be-processed three-dimensional image data comprises performing non-rigid alignment on the reference three-dimensional image data that has been aligned with an (i−1)-th frame of to-be-processed three-dimensional image data based on an i-th frame of the N frames of to-be-processed three-dimensional image data to obtain the reference three-dimensional image data aligned with the i-th frame of to-be-processed three-dimensional image data, wherein i is a positive integer greater than 1.

10. A non-transitory computer-readable storage medium, wherein instructions in the computer-readable storage medium, when executed by a processor of an electronic device, cause the electronic device to perform a three-dimensional image data generation method, comprising:
acquiring N frames of to-be-processed three-dimensional image data of a target object, wherein the N frames of to-be-processed three-dimensional image data comprise a to-be-processed three-dimensional image data sequence of a target part of the target object obtained within a target period of time, wherein N is a positive integer greater than 1;
performing rigid alignment on reference three-dimensional image data based on a first frame of the N frames of to-be-processed three-dimensional image data; and
performing non-rigid alignment on the rigidly aligned reference three-dimensional image data based on the N frames of to-be-processed three-dimensional image data so as to determine a target three-dimensional image data sequence of the target object; wherein the performing non-rigid alignment on the rigidly aligned reference three-dimensional image data based on the N frames of to-be-processed three-dimensional image data comprises performing non-rigid alignment on the reference three-dimensional image data that has been aligned with an (i−1)-th frame of to-be-processed three-dimensional image data based on an i-th frame of the N frames of to-be-processed three-dimensional image data to obtain the reference three-dimensional image data aligned with the i-th frame of to-be-processed three-dimensional image data, wherein i is a positive integer greater than 1.

11. (canceled)

12. The electronic device according to claim 9, wherein the performing non-rigid alignment on the rigidly aligned reference three-dimensional image data comprises:
performing non-rigid alignment on the rigidly aligned reference three-dimensional image data based on the N frames of to-be-processed three-dimensional image data and target constraint conditions; wherein the target constraint conditions comprise at least one of the following: nearest neighbor constraint, smoothness constraint, rigidity constraint, and key point constraint.

13. The electronic device according to claim 12, wherein the performing non-rigid alignment on the rigidly aligned reference three-dimensional image data based on the N frames of to-be-processed three-dimensional image data and the target constraint conditions comprises:
performing non-rigid alignment on the rigidly aligned reference three-dimensional image data according to the N frames of to-be-processed three-dimensional image data under the condition that the weighted sum of a function of the nearest neighbor constraint, a function of the smoothness constraint, a function of the rigidity constraint and a function of the key point constraint is minimum;
wherein the function of the nearest neighbor constraint is configured for constraining distances between vertices in the N frames of to-be-processed three-dimensional image data and nearest vertices in the non-rigidly aligned reference three-dimensional image data; the function of the smoothness constraint is configured for constraining Laplace coordinates of vertices in the non-rigidly aligned reference three-dimensional image data; the function of the rigidity constraint is configured for constraining change degrees between the vertices having connection relationships in the non-rigidly aligned reference three-dimensional image data; the function of the key point constraint is configured for constraining distances between key points in the N frames of to-be-processed three-dimensional image data and key points in the non-rigidly aligned reference three-dimensional image data.

14. The electronic device according to claim 12, wherein the target constraint conditions further comprise a non-deformed region constraint, and a function of the non-deformed region constraint is configured for constraining a change degree of non-deformed regions in the non-rigidly aligned reference three-dimensional image data; the performing non-rigid alignment on the rigidly aligned reference three-dimensional image data based on the N frames of to-be-processed three-dimensional image data and the target constraint conditions comprises:
performing non-rigid alignment on the rigidly aligned reference three-dimensional image data according to the N frames of to-be-processed three-dimensional image data under the condition that the weighted sum of the function of the nearest neighbor constraint, the function of the smoothness constraint, the function of the key point constraint, the function of the non-deformed region constraint and the function of the rigidity constraint is minimum.

15. The electronic device according to claim 9, wherein the performing rigid alignment on the reference three-dimensional image data based on the first frame of the N frames of to-be-processed three-dimensional image data comprises: performing rigid alignment between the first frame of to-be-processed three-dimensional image data and the reference three-dimensional image data based on key points of the first frame of to-be-processed three-dimensional image data of the target part, which comprises:
acquiring a first frame of image of the target object, wherein the first frame of image corresponds to the first frame of to-be-processed three-dimensional image data;
extracting key points in the first frame of image;
obtaining three-dimensional key points in the first frame of to-be-processed three-dimensional image data that correspond to the key points;
acquiring labeled three-dimensional key points of the reference three-dimensional image data; and
performing morphing process on the reference three-dimensional image data based on the three-dimensional key points and the labeled three-dimensional key points.

16. The electronic device according to claim 9, wherein the performing non-rigid alignment on the rigidly aligned reference three-dimensional image data based on the N frames of to-be-processed three-dimensional image data comprises:
performing non-rigid alignment on the rigidly aligned reference three-dimensional image data according to the first frame of to-be-processed three-dimensional image data.

17. The electronic device according to claim 9, wherein the method further comprises:
acquiring N frames of initial to-be-processed three-dimensional image data and N frames of images of the target object; wherein the N frames of initial to-be-processed three-dimensional image data correspond to the N frames of images, respectively;
acquiring segmentation masks of the target part corresponding to the N frames of images, respectively;
projecting the N frames of initial to-be-processed three-dimensional image data to a coordinate system corresponding to the N frames of images, respectively, and determining the vertices that do not belong to the target part in the N frames of initial to-be-processed three-dimensional image data based on the segmentation masks; and
removing the vertices that do not belong to the target part in the N frames of initial to-be-processed three-dimensional image data to obtain the N frames of to-be-processed three-dimensional image data of the target object.

18. The non-transitory computer-readable storage medium according to claim 10, wherein the performing non-rigid alignment on the rigidly aligned reference three-dimensional image data comprises:
performing non-rigid alignment on the rigidly aligned reference three-dimensional image data based on the N frames of to-be-processed three-dimensional image data and target constraint conditions; wherein the target constraint conditions comprise at least one of the following: nearest neighbor constraint, smoothness constraint, rigidity constraint, and key point constraint.

19. The non-transitory computer-readable storage medium according to claim 18, wherein the performing non-rigid alignment on the rigidly aligned reference three-dimensional image data based on the N frames of to-be-processed three-dimensional image data and the target constraint conditions comprises:
performing non-rigid alignment on the rigidly aligned reference three-dimensional image data according to the N frames of to-be-processed three-dimensional image data under the condition that the weighted sum of a function of the nearest neighbor constraint, a function of the smoothness constraint, a function of the rigidity constraint and a function of the key point constraint is minimum;
wherein the function of the nearest neighbor constraint is configured for constraining distances between vertices in the N frames of to-be-processed three-dimensional image data and nearest vertices in the non-rigidly aligned reference three-dimensional image data; the function of the smoothness constraint is configured for constraining Laplace coordinates of vertices in the non-rigidly aligned reference three-dimensional image data; the function of the rigidity constraint is configured for constraining change degrees between the vertices having connection relationships in the non-rigidly aligned reference three-dimensional image data; the function of the key point constraint is configured for constraining distances between key points in the N frames of to-be-processed three-dimensional image data and key points in the non-rigidly aligned reference three-dimensional image data.

20. The non-transitory computer-readable storage medium according to claim 18, wherein the target constraint conditions further comprise a non-deformed region constraint, and a function of the non-deformed region constraint is configured for constraining a change degree of non-deformed regions in the non-rigidly aligned reference three-dimensional image data; the performing non-rigid alignment on the rigidly aligned reference three-dimensional image data based on the N frames of to-be-processed three-dimensional image data and the target constraint conditions comprises:
performing non-rigid alignment on the rigidly aligned reference three-dimensional image data according to the N frames of to-be-processed three-dimensional image data under the condition that the weighted sum of the function of the nearest neighbor constraint, the function of the smoothness constraint, the function of the key point constraint, the function of the non-deformed region constraint and the function of the rigidity constraint is minimum.

21. The non-transitory computer-readable storage medium according to claim 10, wherein the performing rigid alignment on the reference three-dimensional image data based on the first frame of the N frames of to-be-processed three-dimensional image data comprises: performing rigid alignment between the first frame of to-be-processed three-dimensional image data and the reference three-dimensional image data based on key points of the first frame of to-be-processed three-dimensional image data of the target part, which comprises:
acquiring a first frame of image of the target object, wherein the first frame of image corresponds to the first frame of to-be-processed three-dimensional image data;
extracting key points in the first frame of image;
obtaining three-dimensional key points in the first frame of to-be-processed three-dimensional image data that correspond to the key points;
acquiring labeled three-dimensional key points of the reference three-dimensional image data; and
performing morphing process on the reference three-dimensional image data based on the three-dimensional key points and the labeled three-dimensional key points.

22. The non-transitory computer-readable storage medium according to claim 10, wherein the performing non-rigid alignment on the rigidly aligned reference three-dimensional image data based on the N frames of to-be-processed three-dimensional image data comprises:
performing non-rigid alignment on the rigidly aligned reference three-dimensional image data according to the first frame of to-be-processed three-dimensional image data.
